(19) United States
(12) Patent Application Publication
(10) Pub. No.: US 2006/0097619 A1
(43) Pub. Date: May 11, 2006

(54) Projection-type cathode ray tube

(76) Inventors: Tetsuo Asano, Mobara (JP); Sakae Watanabe, Mutsuzawa (JP); Go Uchida, Mobara (JP)

Correspondence Address: MILBANK, TWEED, HADLEY & MCCLOY, 1 CHASE MANHATTAN PLAZA, NEW YORK, NY, 10005-1413, US

(21) Appl. No.: 11/266,420

(22) Filed: Nov. 3, 2005

(30) Foreign Application Priority Data
Nov. 4, 2004 (JP) 2004-320770

(51) Int. Cl. H01J 29/86; H01J 29/92; H01J 29/70

(52) U.S. Cl. 313/477 R; 313/422

(57) ABSTRACT

The present invention, to realize a compact projection-type television receiver set, provides a flattened projection-type cathode ray tube of a projection-type television receiver set. The projection-type cathode ray tube includes a phosphor screen panel, a phosphor screen formed on an inner surface of the phosphor screen panel, a face panel which is arranged to face the phosphor screen in an opposed manner, and an electron gun for forming an image on the phosphor screen, wherein the phosphor screen is inclined with respect to a tube axis on which the electron gun is arranged.

### BACKGROUND OF THE INVENTION

1. Field of the Invention

The present invention relates to a projection-type cathode ray tube which aims at the fabrication of a compact projection-type television receiver set.

2. Description of the Related Art

As one of large-sized display devices, a projection-type display device which uses a cathode ray tube has been known. As the cathode ray tube which is used in the projection-type display device (hereinafter referred to as “projection-type cathode ray tube”), a cathode ray tube having a diagonal size of 5.5 inches or a cathode ray tube having a diagonal size of 7 inches are known. The projection-type image display device projects an image formed on a panel portion of the projection-type cathode ray tube to a screen having a size of approximately 40 to 50 inches. To display a color image on the screen, a cathode ray tube which displays a red image, a cathode ray tube which displays a green image and a cathode ray tube which displays a blue image are used and respective color images are overlapped to each other on the screen.

Further, in the projection-type cathode ray tube, a phosphor screen is formed on the inner surface of a face panel and the emitted light on the phosphor screen is led to the outside of the cathode ray tube after passing through the face panel.

In the projection-type cathode ray tube, it is necessary to magnify or enlarge an image projected to the panel having a diagonal size of 7 inches to the screen having a diagonal size of 50 inches, for example. To obtain a sufficiently bright image on the screen, the brightness on the panel of the projection-type cathode ray tube is made relatively high compared to the brightness of a direct-viewing-type cathode ray tube.

Further, in the projection-type cathode ray tube, it is necessary to focus the electron beams to prevent the image from becoming coarse even when the image on the panel is projected to the screen. To enhance the focusing, an electron lens of an electron gun may be large-sized or a distance between a main lens of the electron gun and the phosphor screen may be elongated.

In the projection-type cathode ray tube, since the image of high brightness is displayed on the face panel, a front face of the panel generates high temperature. To suppress the elevation of temperature of the front surface of the panel, a cooling liquid is arranged on the front face of the panel. Further, a plurality of optical lenses for magnifying the image is mounted on a front side of the cooling liquid.

In the conventional projection-type image display device, the image formed by the projection-type cathode ray tube passes through the cooling liquid and the optical lenses and, thereafter, is reflected on a mirror, and is projected on the screen.

In Japanese Patent Laid-open Sho62(1987)-8423(U.S. Pat. No. 4,731,557)), there is disclosed a technique which fills a gap defined between a projection-type cathode ray tube and a projection lens with a liquid so as to cool an optical coupling and a phosphor screen. Further, In Japanese Patent Laid-open Sho58(1983)-44657, there is disclosed a technique which corrects the field curvature aberration using a front wall of a glass bulb of a projection-type cathode ray tube.

### BRIEF SUMMARY OF THE INVENTION

The conventional projection-type cathode ray tube has a large total length which is usually approximately 270 mm. Further, it is necessary to align an axis of the projection-type cathode ray tube and an axis of the optical lenses. Since the projection-type cathode ray tube and the lenses are arranged on a straight line, the total length of the projection-type cathode ray tube including the projection lens becomes large. The total length of the combination of the projection-type cathode ray tube, the liquid coupling portion and the projection lens becomes approximately 380 mm.

Since the image which is displayed on the phosphor screen of the projection-type cathode ray tube is projected to a front portion of the projection-type cathode ray tube, it is impossible to decrease a cabinet size of a projection-type television receiver set. Accordingly, it is difficult to realize a stationary-type television receiver set having a small thickness, while a tabletop type television receiver set cannot reduce the size of a portion below the screen (a console portion).

It is an object of the present invention to provide a projection-type cathode ray tube which can flatten the projection-type cathode ray tube of a projection-type television receiver set for realizing a compact projection-type television receiver set.

A projection-type cathode ray tube according to the present invention includes a vacuum envelope which is formed of a panel portion, a neck portion having an electron gun which irradiates electron beams, and a funnel portion which connects the panel portion and the neck portion. The panel portion includes a phosphor screen which emits light in response to the electron beams irradiated from the electron gun, a phosphor screen panel which includes the phosphor screen on an inner surface thereof, and a face panel which is arranged to face the phosphor screen of the phosphor screen panel. A center axis of the phosphor screen is inclined with respect to a tube axis along which the electron gun is arranged, and the emitted light on the phosphor screen is projected to the outside of the vacuum envelope after passing through the face panel.

The projection-type cathode ray tube of the present invention is formed into a flattened tube which has the phosphor screen thereof inclined with respect to the tube axis and hence, it is possible to project an image to a rear upper portion of the tube whereby it is possible to realize a compact projection-type television receiver set.

The projection-type cathode ray tube of the present invention includes the phosphor screen which is constituted of a metal back film which is formed on an inner surface of the phosphor screen panel and is made of aluminum or the like, the phosphor film which is formed on the metal back film, and a conductive film which is formed on the phosphor film, wherein a perpendicular line of the phosphor screen is inclined relative to the tube axis (aligned with a center axis of the electron gun). It is preferable to set an angle θ made by the center axis of the electron gun and the perpendicular line of the phosphor screen to 30 degrees to 60 degrees. Further, the phosphor screen forms a spherical face or non-spherical face and is formed in a concave shape as a whole.

The curved face panel which corrects the field curvature aberration is arranged on a side which faces the phosphor screen and reflection suppressing coating is applied to inner and outer surfaces of the curved panel. By forming the face panel in a curved shape, it is possible to allow the face panel to function as a part which constitutes the vacuum envelope and also as a lens for correcting the field curvature aberration. Accordingly, it is no more necessary to arrange a lens for correcting the field curvature aberration between the face panel and the screen and hence, a distance between the face panel and the screen can be shortened.

A liquid cooling portion or heat radiation fins are arranged on the outside of the phosphor screen for cooling. Since the cooling portion is not interposed between the face panel and the screen, the display of an image is not deteriorated.

In the projection-type cathode ray tube of the present invention, the phosphor film is formed on the metal back film which is formed on the inner surface of the phosphor screen and hence, the influence of browning of the panel portion attributed to the electron beams can be eliminated whereby the deterioration of the brightness can be suppressed.

Further, a thickness of the phosphor screen panel can be reduced and the cooling can be performed on the outer surface of the phosphor screen panel and hence, it is possible to effectively cool the phosphor film. Accordingly, a temperature of the phosphor film during the operation can be lowered and hence, the deterioration of the brightness can be effectively prevented. Further, the cooling can be also performed using the heat radiation fins. In this case, the cooling structure becomes simple and hence, a manufacturing cost can be reduced.

Since the projection-type cathode ray tube according to the present invention has a compact profile, the projection-type cathode ray tube is preferably applicable to an all-purpose projection-type cathode ray tube and a cathode-ray-tube-type back-projection-type television receiver set.

### BRIEF DESCRIPTION OF THE SEVERAL VIEWS OF THE DRAWING

FIG. 1A and FIG. 1B are schematic views of a projection-type cathode ray tube according to the present invention, wherein FIG. 1A is a constitutional view of the projection-type cathode ray tube according to the present invention and FIG. 1B is a constitutional view in which schematic view sizes (unit: mm) of the projection-type cathode ray tube of the present invention are filled out; and

FIG. 2A and FIG. 2B are schematic views of a projection-type television receiver set, wherein FIG. 2A is a front view and FIG. 2B is a side cross-sectional view.

### PREFERRED EMBODIMENTS OF THE INVENTION

Preferred embodiments of the present invention are explained hereinafter in conjunction with attached drawings.

### Embodiment

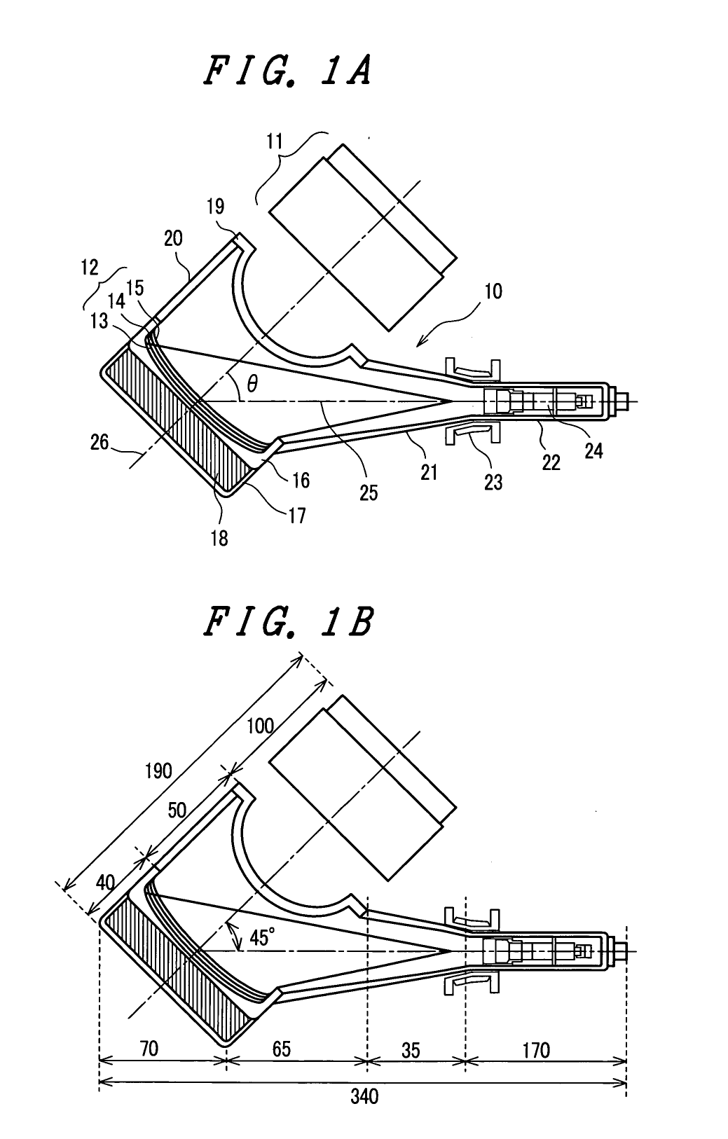

FIG. 1A and FIG. 1B are schematic views of a projection-type cathode ray tube according to the present invention, wherein FIG. 1A is a constitutional view of the projection-type cathode ray tube according to the present invention and FIG. 1B is a constitutional view in which schematic view sizes (unit: mm) of the projection-type cathode ray tube of the present invention are filled out.

A vacuum envelope of a projection-type cathode ray tube 10 shown in FIG. 1A is constituted of a panel portion, a neck portion 22 which includes an electron gun 24 which emits electron beams, and a funnel portion 21 which connects the panel portion and the neck portion, wherein the inside of the vacuum envelope is held in a vacuum. The panel portion is constituted of a phosphor screen panel 16, a face panel 19 which is arranged to face the phosphor screen panel 16 by way of a vacuum region, and a side wall portion 20 which surrounds a portion between the phosphor screen panel 16 and the face panel 19.

It is preferable that the panel portion, the neck portion and the funnel portion which constitute the vacuum envelope are formed of glass. By forming the vacuum envelope using glass, it is possible to use a conventional manufacturing process. That is, it is possible to ensure the reliability of frit welded portions with the use of the glass-made phosphor screen and the glass-made face panel.

Further, on an inner surface of the phosphor screen panel 16, a phosphor screen 12 which emits light when electron beams emitted from the electron gun impinge thereon is formed. The phosphor screen 12 is formed by arranging a metal back film 13, a phosphor film 14 and a conductive film 15 on the inner surface of the phosphor screen panel 16 in this order from the phosphor screen panel side. The light generated on the phosphor screen 12 is led to the outside of the cathode ray tube 10 after passing through the face panel 19 which is arranged to face the phosphor screen 12 in an opposed manner by way of the vacuum region defined in the inside of the vacuum envelope.

In the projection-type cathode ray tube of the present invention, the phosphor film is formed on the metal back film which is formed on the inner surface of the phosphor-screen glass panel and hence, the influence of browning of the panel portion attributed to the electron beams can be eliminated whereby the deterioration of the brightness can be suppressed. Further, even when the browning is generated on the phosphor-screen glass panel, the light which is generated on the phosphor screen does not pass through the glass panel of the phosphor screen and hence, an image which is projected on the screen is not influenced. That is, the projection-type cathode ray tube of the present invention can eliminate the deterioration of brightness of the image and a coloring problem attributed to the browning.

The electron gun 24 is arranged in the inside of the neck portion 22 and, at the same time, a center axis 25 of the electron gun 24 is arranged to be inclined relative to a normal line 26 of a center portion of the phosphor-screen glass panel 16. That is, an angle θ made by the normal line of the center portion of the phosphor screen and the tube axis is set to a value which falls within a range of 0°<θ<90°. In the projection-type cathode ray tube shown in FIG. 1B, the angle θ made by the tube axis 25 and the perpendicular line 26 is set to 45 degrees. Provided that the angle θ is set to a value which falls within a range of 30 degrees to 60 degrees, a strain of the image is small and hence, it is possible to ensure the favorable focusing. When the angle θ becomes smaller than 30 degrees, the neck portion and a projection lens interfere with each other and hence, it becomes difficult to display an image. When the angle θ becomes larger than 60 degrees, an incident angle of the electron beams on the phosphor screen becomes large and hence, electron beam spots on the phosphor screen are formed in an elliptical shape whereby the resolution is degraded.

The projection-type cathode ray tube of the present invention is a flattened tube which inclines the phosphor screen with respect to the tube axis and hence, the cathode ray tube can project an image to a rear upper portion of the tube whereby a projection-type television receiver set can be formed in a compact shape.

Here, in a 46-inch-wide-type projection-type television receiver set which is provided with the projection-type cathode ray tube of the present invention, a depth of a stationary-type projection-type television receiver set can be shortened to 380 mm, while a console size of a tabletop-type projection-type television receiver set can be shortened to 250 mm.

Further, a depth of a 51-inch-wide-type stationary-type projection-type television receiver set which is provided with the projection-type cathode ray tube of the present invention can be shortened to 400 mm. Since a depth of a conventional 51-inch-wide-type stationary-type projection-type television receiver set is 500 mm, the projection-type television receiver set which adopts the projection-type cathode ray tube of the present invention can be shortened by 100 mm compared to the conventional projection-type television receiver set.

Further, a console size of a 51-inch-wide-type tabletop-type projection-type television receiver set which is provided with the projection-type cathode ray tube of the present invention can be shortened to 250 mm. Since a console size of a conventional 51-inch-wide-type tabletop-type projection-type television receiver set is 400 mm, the projection-type television receiver set which adopts the projection-type cathode ray tube of the present invention can be shortened by 150 mm compared to the conventional projection-type television receiver set.

Here, on an outside of the neck portion 22, although not shown in the drawings, an electron beam shape correction magnet assembly is mounted.

Further, on an outside of the phosphor screen panel 16, a cooling portion 17 which is filled with a cooling liquid 18 for lowering a temperature of the phosphor film 14 during an operation is arranged. In the projection-type cathode ray tube, an image of high brightness is displayed on the face panel and hence, the phosphor screen 12 on which the electron beams impinge generates high temperature. By arranging the cooling liquid 18 on a back surface of the phosphor screen panel, it is possible to suppress the elevation of the temperature of the phosphor screen panel. Further, it is possible to allow the image displayed on the phosphor screen to be projected to the screen without passing through the cooling liquid and hence, a strain of the image attributed to the cooling liquid can be eliminated.

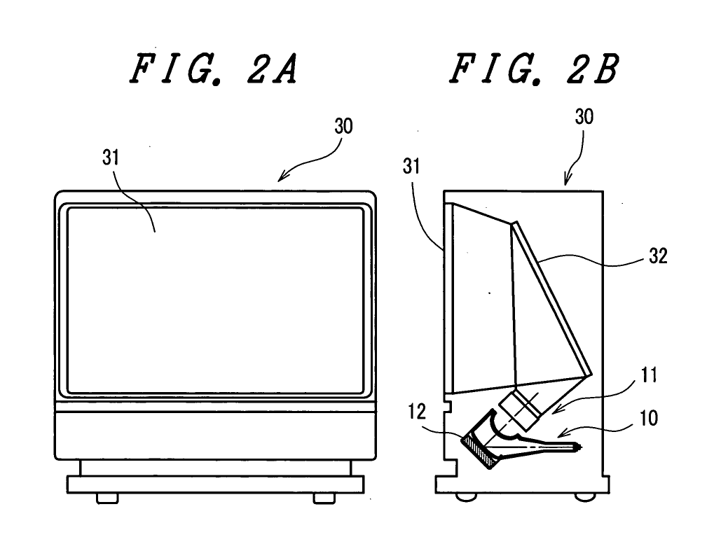

The electron beams irradiated from the electron gun 24 are deflected in the horizontal and vertical directions by a deflecting unit 23 and impinge on the phosphor film 14 of the phosphor screen 12 so as to cause the phosphor film 14 to emit light thus forming an image. The image formed by the phosphor film 14 is reflected on the metal back film 13, passes through the conductive film 15 to which a high voltage is applied, and is led to the outside of the vacuum envelope after passing through the face panel 19. The light irradiated from the projection-type cathode ray tube is projected on a screen 31 (shown in FIG. 2B) after passing through the projection lens 11 and a reflection mirror 32 (shown in FIG. 2B).

The face panel 19 having inner and outer surfaces to which reflection suppressing coating is applied and the projection lens 11 constitute a projection optical system. The face panel 19 is formed in a curved shape to correct the field curvature aberration. Further, since a cooling liquid is not present between the face panel 19 and the projection lens 19, it is possible to project a favorable image on the screen.

The phosphor screen is formed in a curved face having a concave shape. Further, the phosphor screen is formed in a spherical shape having a radius of curvature of approximately 350 mm or a non-spherical shape and is formed in a concave shape as a whole.

A phosphor screen of a conventional projection-type cathode ray tube is formed on an inner surface of a face glass panel having a convex-shape inside the cathode ray tube. Accordingly, an incident angle of the electron beam to the phosphor screen is increased as an impinging point approaches to a periphery of a panel and hence, an image is blurred at a periphery of the screen.

With respect to the phosphor screen of the projection-type cathode ray tube according to the present invention, the face panel and the phosphor screen are formed separately from each other and hence, it is possible to form a shape of the phosphor screen arbitrarily. Accordingly, it is possible to form the optimum phosphor screen shape without being restricted by the inner surface shape of the face panel. In this embodiment, the phosphor screen is formed in a concave shape and hence, the blurring of an image on a peripheral portion of the screen can be effectively prevented.

FIG. 2A is a front view of a projection-type television receiver set which adopts the projection-type cathode ray tube of the present invention, while FIG. 2B is a side cross-sectional view of the projection-type television receiver set which adopts the projection-type cathode ray tube of the present invention.

In the inside of the projection-type television receiver set 30, although not shown in the drawing, three projection-type cathode ray tubes 10 of red, green and blue are arranged. Each projection-type cathode ray tube 10 includes a projection lens 11 and images formed on the phosphor screens 12 of the respective projection-type cathode ray tubes are magnified by the respective projection lens 11 and are synthesized on the screen 31 by way of the reflection mirror 32.

In the projection-type television receiver set provided with the projection-type cathode ray tube of the present invention, the normal line of the phosphor screen and the center axis of the electron gun are not aligned with each other. Accordingly, it is possible to project the image to the rear upper portion of the tube and hence, it is possible to provide the compact projection-type television receiver set.

What is claimed is:

1. A projection-type cathode ray tube comprising a vacuum envelope formed of a panel portion, a neck portion having an electron gun which irradiates electron beams, and a funnel portion which connects the panel portion and the neck portion, wherein
the panel portion including a phosphor screen panel which includes a phosphor screen on an inner surface thereof, and a face panel which is arranged to face the phosphor screen of the phosphor screen panel,
a center axis of the phosphor screen is inclined with respect to a tube axis along which the electron gun is arranged, and
the emitted light on the phosphor screen is projected to the outside of the vacuum envelope after passing through the face panel.

2. A projection-type cathode ray tube according to claim 1, wherein an angle of the inclination is 30 degrees to 60 degrees.

3. A projection-type cathode ray tube according to claim 1, wherein the phosphor screen is formed by arranging a metal back film, a phosphor film and a conductive film on an inner surface of the phosphor screen panel in this order from the phosphor screen panel side.

4. A projection-type cathode ray tube according to claim 1 or 3, wherein the phosphor screen has a concave curved surface.

5. A projection-type cathode ray tube according to claim 1, wherein the face panel is formed in a curved shape which corrects a field curvature aberration.

6. A projection-type cathode ray tube according to claim 1 or 5, wherein reflection suppressing coating is applied to inner and outer surfaces of the face panel.

7. A projection-type cathode ray tube according to claim 1, wherein a cooling portion is formed on the outside of the phosphor screen panel.
